(19) United States
(12) Patent Application Publication
(10) Pub. No.: US 2014/0270041 A1
(43) Pub. Date: Sep. 18, 2014

(54) Actinide Oxide Structures For Monitoring A Radioactive Environment Wirelessly

(71) Applicant: Idaho State University, (US)

(72) Inventors: Eric A. Burgett, Pocatello, ID (US); Tony S. Hill, Idaho Falls, ID (US)

(73) Assignee: Idaho State University, Pocatello, ID (US)

(21) Appl. No.: 13/800,451

(22) Filed: Mar. 13, 2013

(51) Int. Cl. G21C 17/10

(52) U.S. Cl. CPC G21C 17/10
USPC 376/259

(57) ABSTRACT

Various embodiments enable wireless monitoring of a radioactive environment and related operating conditions. Structures of increasing complexity and formed at least in part from a semiconductor material based on crystalline actinide oxide-based material enable monitoring at least one operating conditions of the radioactive environment. An exemplary embodiment is a device comprising one or more crystal oscillator units that can generate a first oscillating signal, and an actinide oxide-based unit functionally coupled to at least one of the one or more crystal oscillator units, and configured to receive the first oscillating signal. The actinide oxide-based unit can supply a second oscillating signal to an antenna that delivers the second oscillating signal wirelessly, wherein the second oscillating signal is based on the first oscillating signal and is indicative of an operating condition of the radioactive environment. The antenna is part of the radioactive environment.

### SUMMARY

In accordance with various aspects and exemplary embodiments described herein, the subject disclosure generally relates to wireless monitoring of a radioactive environment. Various embodiments described herein exploit structures of increasing complexity and related architectures formed at least in part from a semiconductor material made from a crystalline actinide oxide-based material, such as crystalline urania of semiconductor grade. In one aspect, such embodiments enable monitoring of one or more operating conditions of the radioactive environment. Operating conditions that can be monitored in accordance with aspects of the subject disclosure can comprise one or more of reactor fuel consumption, temperature of a reactor fuel element, temperature of coolant, coolant flow rate, coolant flow steam quality, fuel conditions, neutron spectrum and output power of the nuclear reactor. In another aspect, certain embodiments can provide a general power source and wireless transmission structures for in-core instrumentation or for monitoring systems that can be applied to collection of data, and analysis thereof, associated with nuclear fuel conditions. The structures and related architectures (e.g., devices) can be utilized in various scenarios, such as in the interior of an operating nuclear reactor, in the spent fuel pool after irradiation and burning, in dry storage or long term repository storage.

In an aspect, the subject disclosure provides an exemplary device comprising one or more crystal oscillator units that can generate a first oscillating signal, and an actinide oxide-based unit functionally coupled to at least one of the one or more crystal oscillator units, and configured to receive the first oscillating signal. The actinide oxide-based unit can supply a second oscillating signal to an antenna that delivers the second oscillating signal wirelessly, wherein the second oscillating signal is based on the first oscillating signal and is indicative of an operating condition of the radioactive environment. The antenna is part of the radioactive environment.

In another aspect, the subject disclosure provides an exemplary method, comprising providing an actinide oxide-based unit comprising a processing circuit and a power source that energizes at least the processing unit; generating by the processing circuit an oscillating signal indicative of a condition of a nuclear reactor core; coupling the actinide oxide-based unit to a nuclear fuel structure of the nuclear reactor core; and delivering wirelessly the oscillating signal through at least a portion of the nuclear fuel structure of the nuclear reactor core, wherein the portion of the fuel structure serves as an antenna.

In yet another aspect, the subject disclosure provides an exemplary method, comprising: acquiring electromagnetic radiation (EM) or charged-particle radiation (CP) generated by an actinide oxide-based detector in response to an operating condition of a nuclear reactor core comprising the actinide oxide-based detector: and extracting data indicative of the operating condition of the nuclear reactor core from at least the EM radiation.

In yet another aspect, the subject disclosure provides an exemplary method, comprising: acquiring electromagnetic radiation (EM) or charged-particle radiation (CP) generated by an actinide oxide-based device and through the ionization events in the semiconductor uranium oxide structure produce an electric charge and voltage for providing a means of remotely powering this and other devices.

For a radioactive environment embodied in a nuclear reactor core, providing data related to operating conditions of the nuclear reactor core through the various embodiments of the subject disclosure can enable an engineer or other professional to assess conditions pertinent to operation of the nuclear reactor, such as boiling height, steam quality, fuel depletion, etc.

Additional advantages of the subject disclosure will be set forth in part in the description which follows, and in part will be apparent from such description and annexed drawings, or may be learned by practice of the subject disclosure. The advantages of the subject disclosure can be realized and attained by means of the elements and combinations particularly pointed out in the appended claims. It is to be understood that both the foregoing general description and the following detailed description are exemplary and explanatory only and are not restrictive of the various aspects, features, or advantages of the subject disclosure.

### BRIEF DESCRIPTION OF THE DRAWINGS

The accompanying drawings, which are incorporated in and are a part of the subject specification, illustrate several exemplary embodiments of the subject disclosure and together with the description, serve to explain the principles set forth in the subject disclosure.

FIG. 1 illustrates stages of an exemplary protocol for monitoring operating condition of a radioactive environment in accordance with aspects disclosed herein.

FIG. 2 illustrates a group of manufacturing stages that enable production of an actinide oxide-based structure (e.g., units, devices) for monitoring an operating condition of a radioactive environment in accordance with aspects of the subject disclosure.

FIGS. 3A-3B illustrate exemplary actinide oxide-based structures in accordance with aspects of the subject disclosure.

FIGS. 4A-4B illustrate other exemplary actinide oxide-based structures in accordance with aspects of the subject disclosure.

FIGS. 5A-5B illustrate yet other exemplary actinide oxide-based structures in accordance with aspects of the subject disclosure.

FIG. 6 illustrates an exemplary system that monitors operating conditions of a radioactive environment (e.g., radioactive environment 140) in accordance with aspects of the subject disclosure.

FIG. 7 illustrates an exemplary embodiment of an exemplary system that monitors operating conditions of a radioactive environment (e.g., core of a nuclear reactor) in accordance with aspects of the subject disclosure.

FIGS. 8-9 illustrate an exemplary method for producing and emitting wireless signal indicative of an operating condition of a radioactive environment (e.g., core of a nuclear reactor) in accordance with aspects of the subject disclosure.

FIG. 10 illustrates an exemplary method detecting the wireless signal representative of an operating condition of a radioactive environment (e.g., core of a nuclear reactor) in accordance with aspects of the subject disclosure.

### DETAILED DESCRIPTION

The subject disclosure may be understood more readily by reference to the following detailed description of exemplary embodiments of the subject disclosure and to the Figures and their previous and following description.

Before the present compounds, compositions, articles, devices, apparatuses, systems, and/or methods are disclosed and described, it is to be understood that the subject disclosure is not limited to specific synthetic methods, specific materials and material combinations, or to particular shapes or morphologies, as such may, of course, vary. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Thus, for example, reference to “an integrated circuit” refers to a single integrated circuit or to combinations of two or more integrated circuits, reference to “a crystal oscillator unit” includes combinations of two or more ring oscillators, which can be coupled either directly or indirectly, reference to “a crystalline oxide material” refers to a single material or several or to two or more such stages, and the like.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about.” it will be understood that the particular value forms another embodiment. It will be further understood that the endpoints of each of the ranges are significant both in relation to the other endpoint, and independently of the other endpoint.

In the subject disclosure and in the claims which follow, reference will be made to a number of terms which shall be defined to have the following meanings: “Optional” or “optionally” means that the subsequently described event or circumstance may or may not occur, and that the description includes instances where said event or circumstance occurs and instances where it does not.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Throughout the description and claims of the subject specification, the word “comprise” and variations of the word, such as “comprising” and “comprises,” means “including but not limited to,” and is not intended to exclude, for example, other additives, components, integers, steps, acts, and so forth. In addition, the terms “including” and “having” are employed in the subject disclosure in the same manner as the term “comprising.” “Exemplary” means “an example of” and is not intended to convey an indication of a preferred or ideal embodiment. “Such as” is not used in a restrictive sense, but for explanatory purposes.

Reference will now be made in detail to several exemplary embodiments of a phase-change oscillator and pulse generator in accordance with aspects of the subject disclosure. Wherever possible, the same reference numbers are used throughout the drawings to refer to the same or like parts.

As discussed in greater detail below, one or more embodiments of the subject disclosure provide a wireless in-core monitoring system for reactor health monitoring. Various embodiments described herein exploit structures and related architectures formed at least in part from a semiconductor material made from a crystalline actinide oxide-based material, such as crystalline urania of semiconductor grade. This is a novel reactor monitoring system and power generation technology, based in part on manufacturing and processing large crystalline actinide oxide-based materials. Semiconductor properties of the actinide oxide-based can be customized (e.g., created, adjusted, created and adjusted, or the like) through doping or co-doping of a crystalline intrinsic actinide-oxide based material or through control of oxygen stoichiometry. The various embodiments of the subject disclosure enable realtime monitoring of one or more of several nuclear reactor operating conditions (also referred to as “reactor health”); monitoring can be performed continuously (e.g., realtime) or substantially continuously (e.g., nearly realtime) or at specific instants (e.g., according to a schedule or in response to reactor servicing). As an example, reactor fuel consumption, commonly known as fuel burnup, can be monitored. As another example, temperature of a reactor fuel element (e.g., a fuel rod) can be monitored. As yet another example, fuel conditions (also referred to as “fuel health”) can be monitored. As other examples, neutron spectrum and output power of the nuclear reactor can be monitored. Providing such data through the various embodiments of the subject disclosure can enable an engineer or other professional to assess (infer or otherwise determine, report, etc.) conditions pertinent to operation of the nuclear reactor, such as boiling height, steam quality, fuel depletion, etc. In The devices formed in accordance with aspects of the disclosure can be utilized during operation in a nuclear reactor, in the spent fuel pool following irradiation and burning, in dry storage, or long term repository storage to monitor the health of nuclear fuel or to serve as a power source or a wireless transmission element, or both, for various instruments (e.g., monitoring systems) in a radioactive environment.

Referring to the drawings, FIG. 1 is a diagram 100 of stages of an exemplary protocol for monitoring operating conditions of a radioactive environment in accordance with aspects disclosed herein. One or more embodiments of the subject disclosure can enable, at least in part, the illustrated stages. In structure provisioning stage 110 a plurality of functional elements (components, units, devices, apparatuses, etc.) are manufactured. Such functional elements have architectures that are modular and of increasing complexity, which can be dictated by several operational factors, including budgetary constraints, manufacturing facilities available to implement structure provisioning stage 110, intended operating condition to be monitored, spatial resources within the radioactive environment that are available to deploy such structures, or the like. In certain embodiments, structures produced at structure provisioning stage 110 can be monolithic-functional elements (units, devices, connectors, interconnectors, traces, and masks or contacts, etc.) are integrated through combination of various stages of manufacturing and material processing (polishing, plasma etching, wet etching, dry etching, lithography, photolithography, etc.). However, it should be appreciated that non-monolithic devices also can be produced at structure provisioning stage 110. Non-monolithic devices can integrate monolithic structures (e.g., P-N junctions, N-P junctions, P-N-P junctions) into a functional element, such as amplifiers, transducers, or the like.

Structures produced at structure provisioning stage 110 can be deployed in the interior of the radioactive environment 140 and enable in situ monitoring stage 120 and wireless delivery stage 130. In an embodiment, radioactive environment 140 is a core of a nuclear reactor. Operating conditions in such environment can be extreme, with temperatures temperature and pressures ranging from about 200° C. to about 2100° C. and about 1 atmosphere to about 150 atmospheres, respectively, and intense radiation fields In another embodiment, the radioactive environment can be the site of nuclear attack or accident. In yet another embodiment, the radioactive environment can be an uncharted extra-terrestrial location.

In an aspect of the subject disclosure, in situ monitoring stage 120 and wireless delivery stage 130 can be conducted within the confines of the radioactive environment 140. Such stages can be conducted continuously, nearly continuously, or at certain instants (e.g., in accordance with a schedule). At in situ monitoring stage 120, signals indicative of an operating condition of the radioactive environment 140 are produced. One or more devices can produce such signal. In an exemplary embodiment, a single device can generate and process signals (e.g., electric current, electric voltage, etc.) that are indicative of at least one operating condition of the radioactive environment 140. Such exemplary device can comprise one or more crystal oscillator units that can generate a first oscillating signal.

In addition, at in situ monitoring stage 120, signals are supplied to one or more functional elements (units, devices, apparatuses, etc.) that implement at least part of wireless delivery stage 130. In the latter, signals are processed in a manner suitable for wireless delivery; for instance, a signal received from in situ monitoring stage 120 can be modulated, amplified or filtered, up-converted or down-converted, multiplexed, or the like, and supplied to an antenna structure. In an aspect, the antenna structure is part of the radioactive environment 140. In another aspect, the signal can be modulated or multiplexed in accordance with a predetermined modulation and multiplexing schemes. As an illustration, the exemplary device of the previous exemplary embodiment can comprise an actinide oxide-based unit functionally coupled to at least one of the one or more crystal oscillator units. The actinide oxide-based unit can be configured to receive a first oscillating signal and supply (e.g., generate and deliver) a second oscillating signal to the antenna structure, which in turn can deliver the second oscillating signal wirelessly. Accordingly, the second oscillating signal is based on the first oscillating signal and is indicative of an operating condition of the radioactive environment. The second oscillating signal is suitably processed for wireless delivery, as described hereinbefore.

The exemplary device that performs in situ monitoring stage 120 and wireless delivery stage 130 can embody an actinide oxide-based detector, which generates an oscillating signal in response to an operating condition of the radioactive environment 140 (e.g., a nuclear reactor core) and delivers, via an antenna structure, the oscillating signal. Such detector can be one of a plurality of structures of increasing complexity that are provided in structure provisioning stage 110.

Signals produced in wireless delivery stage 130 can be embodied in the electromagnetic radiation (EM) that has been processed and conveyed in the wireless delivery stage 130. In wireless detection stage 150, at least a portion of such electromagnetic radiation (EM) can be acquired, and data indicative of the operating condition of the radioactive environment 140 (e.g., a nuclear reactor core) can be extracted from at least the EM radiation. One or more functional elements (units, devices, apparatuses, etc.) can extract such data.

Implementation of the foregoing stages depicted in diagram 100 can be accomplished through several functional elements and other stages included in one or more of structure provisioning stage 110, in situ monitoring stage 120, wireless delivery stage 130, or wireless detection stage 150. Illustrative aspects of such implementation are described in detail hereinafter.

FIG. 2 illustrates an exemplary bottom-up approach 200 to production of actinide oxide-based monitoring units in accordance with aspects of the subject disclosure. Such approach can embody structure provisioning stage 110. Deposition stage 204 (also referred to as deposition 204) allows part of fabrication of an actinide oxide-based unit 240 that serves as a monitoring unit for a radioactive environment. The actinide oxide-based unit 240 can have various degrees of complexity and, in certain embodiments, the actinide-based unit 240 is monolithic. Deposition stage 204 can be implemented in accordance with various deposition techniques, including chemical vapor deposition (CVD), such as metal organic CVD (MOCVD); physical vapor deposition (PVD), such as electron beam PVD; molecular beam epitaxy (MBE), or the like. Such deposition techniques can enable the various stages of manufacturing that enable provision of the actinide oxide-based unit 240.

In an aspect, deposition stage 204 comprises fabrication of the actinide based-oxide based unit by MOCVD. Fabrication by MOCVD enables production of a crystalline actinide oxide material that can be part of the actinide oxide-based unit 240. In certain embodiments, the actinide oxide-based unit 240 can include a crystalline actinide oxide material (UₓO_{y}, ThᵤOᵥ, Am_{q}Oₚ, etc.; indices x, y, u, v, q, and p are real numbers that convey composition of the oxide). In an aspect, such material can be a monocrystalline actinide oxide solid, a polycrystalline actinide oxide solid, or a combination thereof. In another aspect, the crystalline actinide oxide material can include an intrinsic actinide oxide material (e.g., material 210), an N-type actinide oxide material (e.g., material 220), a P-type actinide oxide material (material 230), or a combination thereof (see, e.g., FIGS. 3A-3B, FIGS. 4A-4B, and FIGS. 5A-5B).

Deposition 204 also enables fabrication of intrinsic materials that are heterogeneous and comprise disparate actinide oxide-based materials. For example, material 210 is intrinsic and can comprise a layered heterostructure of a first actinide oxide-based material (represented with open blocks) and a second actinide oxide-based material (represented with solid blocks). The second actinide oxide-based material can be different from the first one; for example the first actinide oxide-based material can be U_{y}Oₓ, such as UO₂, and the second actinide oxide-based material can be ThₛOₜ. In addition, the second actinide oxide-based material can be an isotopic enriched realization of the first actinide oxide-based material. For example, isotopic enriched realization of the first actinide oxide-based material can comprise uranium oxide enriched with one or more isotopes comprising ²³³U, ²³⁴U. ²³⁵U, or ²³⁸U. For another example, the first actinide oxide-based material can comprise plutonium oxide enriched with one or more isotopes comprising ²³⁸Pu, or ²³⁹Pu. In yet another example, the first actinide oxide-based material can be thorium oxide enriched with one or more isotopes comprising ²³²Th. In still another example, the first actinide oxide-based material can comprise americium enriched with one or more isotopes comprising ²⁴¹Am.

As indicated in a previous passage, intrinsic actinide oxide-based materials produced in deposition stage 204 can be doped at doping stage 208 (also referred to as doping 208). Fabrication by MOCVD also can enable production of the P-type actinide oxide material by doping the intrinsic actinide oxide material with at least one of a transition metal, a metal, or a metalloid. For instance, Si, Al, In, Pt, Ir, Os, As, Ga, or Zn can be employed as a dopant for P-type doping. Dopants can be introduced via precursor sources in the MOCVD evaporator. In the alternative or in addition, fabrication by MOCVD also enables co-doping of the intrinsic actinide oxide material (e.g., material 240) with two or more transition metals, metals, or metalloids also can be exploited to produce the P-type actinide oxide material (e.g., material 230). In another aspect, fabrication by MOCVD can include production of the N-type actinide oxide material (e.g., material 220) by doping the intrinsic actinide oxide material (e.g., material 210) with at least one of carbon, nitrogen, phosphorus, arsenic, antimony, bismuth or boron. Co-doping with carbon or boron or other combination of elements also is possible.

In additional or alternative embodiments, fabrication by MOCVD also can enable production of the P-type actinide oxide material (material 230) through regulation of oxygen stoichiometry in the intrinsic actinide oxide material (e.g., material 210) via MOCVD. Similarly, yet not identically, in other alternative or further embodiments, fabrication by MOCVD also can enable production of the N-type actinide oxide material (material 220) through regulation of oxygen stoichiometry in the intrinsic actinide oxide material (210) via MOCVD. It is noted that most any fabrication process that enables regulation of oxygen stoichiometry of an intrinsic actinide oxide material can be exploited to produce the P-type actinide oxide material (e.g., material 230) or the N-type actinide oxide material (e.g., material 230).

Doping accomplished through regulation of oxygen stoichiometry yields P-type and N-type materials with an elevated or the most elevated radiation tolerance compared to other actinide oxide-based materials produced through deposition 204 and doping 208. In one aspect, elevated resilience to radiation stems, at least in part, from low or minimal damage to the crystalline lattice of the intrinsic actinide oxide-based material that is being doped via regulation of oxygen stoichiometry. In another aspect, elevated resilience to radiation stems, at least in part, from absence of migration of P-type dopant atoms or N-type dopant atoms in response to thermal gradients, since the doping is accomplished through regulation of oxygen stoichiometry rather than inclusion of dopant atoms.

Deposition 204 and doping 208 can be implemented in a variety of sequences as part of an assembly and processing (A/P) stage 212 (also referred to as A/P 212). Such sequences generally are dictated, at least in part, by manufacturing recipes specific to an intended, or target, actinide oxide-based unit 240. FIGS. 3A-3B and FIGS. 4A-4B illustrate exemplary junctions that can be produced in the A/P stage 212. Exemplary P-N junction 310 comprises an assembly of a P-type actinide oxide material (e.g., material 314) and an N-type actinide oxide material (e.g., material 318). P-N junction 310 also operates as a thermopile in the presence of a heat supplied by a radioactive environment containing such junction. In such scenario, P-N junction 310 can supply a direct current (DC) voltage ΔV=V⁽⁺⁾−V⁽⁻⁾, with ΔV of about 1.2 V and an output power of the order of a mW. Two or more P-N junctions can be functionally coupled in serial fashion to accomplish a desired net DC voltage output and output power. Desired DC voltages and output power can be dictated by allowed or intended (e.g., designed to penetrate a container structure that encompasses the radioactive environment) transmit power of wireless signals supplied in accordance with aspects of the subject disclosure. As an example, the transmit power of wireless signals can range from about 1 Watt to about few hundred Watts. Through selection of higher specific activity actinides, and integration of larger number of structures, a higher output can be obtained (e.g., on the order several thousand Watts). Other structures can be produced, such as exemplary P-i-N junction 360 comprising an assembly of a P-type actinide oxide material (material 364), an intrinsic (i) actinide oxide material (e.g., material 362), and an N-type actinide oxide material (e.g., material 368). Similarly, yet not identically, to junction 310, P-i-N junction 360 can operate as thermopile supplying a DC voltage ΔV=V⁽⁺⁾−V⁽⁻⁾≈1.2 V and output power of the order of a mW within the radioactive environment. Two or more P-i-N junctions can be functionally coupled in serial fashion to accomplish a desired net DC voltage output and output power. As described hereinbefore, the desired output power can be designed to penetrate a container structure that encompasses the radioactive environment. Assembly and processing stage 212 also enables production of N-i-P junctions (not shown) comprising a P-type actinide oxide material, an intrinsic actinide oxide material, and an N-type actinide oxide material.

FIGS. 4A-4B present other exemplary junctions that can be produced through A/P 212. Exemplary P-N-P junction 410 comprises a P-type actinide oxide material (material 414 and material 422) and an N-type actinide oxide material (e.g., material 418). Exemplary N-P-N junction 460 comprises a P-type actinide oxide material (material 464 and material 472) and an N-type actinide oxide material (e.g., material 468). In certain embodiments, semiconductor-on-insulator (SOI) units (junctions, devices, integrated circuits, etc.) also can be manufactured. As illustrated in FIG. 5A, a P-i-N junction (e.g., junction 510) can be deposited onto an insulator (e.g., insulator 514) residing on a substrate (e.g., substrate 518). Similarly, yet not identically, FIG. 5B, illustrates an N-i-P junction (e.g., junction 560) deposited onto the insulator (e.g., insulator 514) residing on the substrate (e.g., substrate 518). In one embodiment, the substrate can be cut from a large (e.g., 1-2 inch diameter) ingot, or boule, of a crystal of the actinide oxide-based material (e.g., UₓO_{y} such as UO₂ or U₃O₈) oriented along a specific crystalline direction [symbol] qrs [symbol] with q, r, s being Miller indices. Such ingot can be grown through CVD or bulk crystal growth. In another embodiment, the substrate and the junction(s) deposited thereon can be non-macroscopic, having sizes commensurate with sizes of individual crystalline grains present in a sintered fuel pellet. Sizes of such grains can range from about a few nanometers to about a few thousand micrometers.

Through implementation (e.g., execution) of one or more manufacturing recipes, A/P 212 can enable fabrication of the actinide oxide-based unit 240. In an aspect, A/P 212 allows fabrication of elementary blocks (junctions, SOI junctions, etc.) as described hereinbefore. Based on such elementary blocks (e.g., at least one of P-N junction(s), N-P-N junction(s), P-N-P junction(s), P-i-N junction(s), or combination thereof), A/P 212 enables manufacture of the actinide oxide-based unit 240 by enabling manufacture of one or more blocks (logic circuits, analog circuits, digital circuits, etc.) of increasing complexity (e.g., structural complexity, functional complexity). In an aspect, A/P 212 and related production of the one or more blocks can include processing the elementary blocks with semiconductor fabrication techniques (e.g., Si-technology fabrication techniques, GaAs-technology fabrication techniques, or the like) suitably modified to manipulate actinide oxide materials (e.g., UₓO_{y} such as UO₂ or U₃O₈). An exemplary suitable modification can include multi-frequency, ICP-RIE, ultra-cold ICP-RIE, and/or adaptation of etching process(es) to mitigate or minimize contamination. Another exemplary suitable modification can include adaptation of the fabrication technique to permit deposition of high-temperature electric conductors such as aluminum-zinc oxide (AZO). In particular, yet not exclusively, modification of such techniques can include development of techniques that can manipulate a highly-enriched material, such as highly enriched uranium (HEU). In an aspect, the one or more blocks can comprise an actinide oxide-based logic gate, such as an OR gate, an AND gate, a NAND gate, a NOR gate, an XOR gate, and so forth. In another aspect, the one or more blocks can comprise actinide oxide-based filter(s), such as bandpass filter(s). In yet another aspect, the one or more blocks can comprise actinide oxide-based amplifier(s), such as a linear amplifier, a delay amplifier, or the like.

In an aspect, the one or more blocks are part of actinide oxide-based unit 240, and can be designed and produced to accomplish predetermined functionality, such as modulation, multiplexing, filtering, analog-to-digital conversion, digital-to-analog conversion, logic storage, digital communication, digital logic, and so forth. Accordingly, through A/P 212, the one or more blocks can embody processing circuitry 248 which provides actinide oxide-based unit 240 with the functionality described in herein.

Generally, processing circuitry 248 can be embodied in an integrated circuit (IC). Processing circuitry 248 can include passive devices or active devices, or a combination thereof. Processing circuitry 248 includes functional elements (devices, circuits, etc.) of various complexity, such as resistors, capacitors, inductances, junctions, diodes, transistors, logic gates, inverters, filters, amplifiers, and so forth. In addition, such functional elements can contain or can be functionally coupled through one or more of connectivity masks, traces, connectors, vertical interconnector access(es) (VIAs), fabricated from platinum, osmium, iridium, various rare earths, etc. Connectors can be encased in an insulator material, such as tungsten oxide. Processing circuitry 248 also can include circuitry that is highly integrated and operational, such as an application-specific IC (e.g., a Field Programmable Gate Array (FPGA)), a digital signal processor (DSP), or a microprocessor(s). In certain embodiments, such highly integrated and operational circuitry can be programmed, as illustrated with an arrow labeled “Programming.” Programming of the device can be effected after manufacturing or it can be accomplished after deployment or installation of the device. For example, at least a portion of the processing circuitry 248 can be implemented as firmware, with specific programming received during the lifecycle of the actinide oxide-based unit 240.

Actinide oxide-based unit 240 can be self-powering. Such feature can allow the actinide oxide-based unit 240 to energize one or more functional elements (e.g., units or related circuitry) that can deliver wireless signals. One or more power source(s) 244 can be embedded, e.g., during A/P 212, into the actinide oxide-based unit 240. Various actinide oxide-based structures can embody a power source of the one or more power source(s) 244. Such structures can exploit heat present in the radioactive environment containing the actinide oxide-based unit 240, fission byproducts or radioactive sources, such as alpha decay, made available by radioactive nature of at least one of the various actinide oxide-based materials that can be part of actinide oxide-based unit 240. Through interconnecting these structures, and selection of either high or low specific activity radioisotopes, the structure can generate thousands of Watts of electrical power.

FIG. 6 illustrates a block diagram of an exemplary system 600 that monitors operating conditions of a radioactive environment (e.g., radioactive environment 140) in accordance with aspects of the subject disclosure. The exemplary system 600 also can be utilized to energize or provide wireless communication functionality, or both, to other instruments (e.g., monitoring systems) associated with the radioactive environment. In certain embodiments, as described in a previous passage, the radioactive environment can be a core of a nuclear reactor or other loci in the interior of the nuclear reactor. It should be appreciated that other radioactive environments (e.g., dry storage of nuclear fuel, long-term repository of spent nuclear fuel, or the like) also are contemplated. Various functional couplings (e.g., thermal coupling, electric coupling, etc.) pertinent to operation of exemplary monitoring system 600 are represented by arrows. Exemplary system 600 comprises an actinide oxide-based monitoring unit 610, which is functionally coupled to a fixture 620 of the radioactive environment. Such unit embodies the actinide oxide-based unit 240. In addition, the actinide oxide-based monitoring unit 610 is functionally coupled to a set of one or more crystal oscillator unit(s) 630, which also is functionally coupled to the fixture 620. In an aspect, the fixture 620 serves as an antenna (or antenna structure) for wireless delivery of signal. In a scenario in which the radioactive environment is the core of a nuclear reactor, the fixture 620 can be a reactor fuel structure; for instance, the fuel structure can be a cladding of a nuclear fuel rod.

As illustrated, in an embodiment, the actinide oxide-based monitoring unit 610 comprises a processor unit 612 and a power unit 614. In an aspect, power unit 614 energizes at least processor unit 612. Such processor unit 612 includes processing circuitry, which has circuitry that enables processor unit 612 to manipulate data and signaling, both of which can be represented, for example, by applied voltages or currents. By manipulating data and signaling, processor unit 612 can enable various operations, such as reception and delivery of signal, amplification of signal, filtering of signal, modulation of signal, multiplexing of signal, or the like. In an aspect, at least one of the one or more crystal oscillator unit(s) 630 provide a first oscillating signal; processor unit 612 can receive the first oscillating signal and yield a second oscillating signal by processing the first oscillating signal. The second oscillating signal can be processed (e.g., modulated, multiplexed, or the like) to convey data indicative of an operating condition of the radioactive environment. A crystal oscillator unit of the one or more crystal oscillator unit(s) 630 produces an oscillating signal of a specific frequency f. The crystal oscillator unit comprises a solid crystal with a resonance at about frequency f which causes the crystal oscillator unit to supply the oscillating signal (e.g., an analog signal such as voltage, current) at the frequency f or related harmonics. Such frequency f can be a function of the crystallographic orientation (k/m) of the solid crystal, wherein k, l, and m are Miller indices. The solid crystal can be one of a zinc oxide crystal, a silicon oxide crystal, or a zirconium oxide crystal. Other crystals such as but not limited to lithium-7 tantalate, lithium-7 niobate, lithium-7 borate, berlinite, gallium arsenide, lithium tetraborate, aluminum phosphate, bismuth germanium oxide, zirconium titanate, alumina, silicon-zinc ceramic, dipotasium tartrate, gallium phosphate, langasite, langanite, laganate, lead zinc titanate, also are contemplated.

In addition, the specific frequency f also is a function of temperature of a medium in thermal contact with the crystal oscillator unit. For certain crystals (e.g., silica, zirconia), f depends linearly with temperature in the interval ranging from about 0° C. to about 1000° C. Frequency f typically increases with temperature. Since a crystal oscillator of the one or more crystal oscillator unit(s) 630 can be functionally coupled, e.g., thermally coupled either in contact with or connected via a thermal conductor, to the fixture 620, the crystal oscillator can generate a non-processed oscillating signal that is responsive to and thus indicative of a temperature of at least a portion of fixture (e.g., a reactor fuel structure). As described supra, processor unit 612 can process the non-processed oscillating signal and supply a processed oscillating signal that is indicative of the temperature of at least the portion of the fixture. In a scenario in which the fixture 620 is a reactor fuel structure and at least one crystal oscillator is thermally coupled to a fuel element, such a fuel rod, that is part of the reactor fuel structure, the actinide oxide-based monitoring unit 610 can generate an oscillating signal indicative of the temperature of nuclear fuel contained in the nuclear reactor or most any nuclear environment.

In certain embodiments, the one or more crystal oscillator unit(s) 630 can comprise a plurality of crystal oscillator units, wherein each unit of the plurality of crystal oscillator units can be functionally coupled, e.g., thermally coupled, to the fixture 620 in a distributed fashion, with the plurality of crystal oscillator units distributed throughout fixture 620. For example, in an implementation in which the fixture 620 comprises a nuclear fuel element (e.g., a nuclear fuel rod), each of the one or more crystal oscillator units can be thermally coupled at a respective position (or location) on fuel element of the fuel structure. Thus, in one aspect, a crystal oscillator unit C_{K} (K being an integer index that labels such unit) can be thermally coupled to the nuclear fuel element at a position R_{K} (R representing a three-dimensional position vector), and, therefore, C_{K} can generate an oscillating signal (e.g., an analog oscillating signal) having a temperature-dependent frequency f_{K}. Spatial fluctuations of temperature or a gradient of temperature is present in the nuclear fuel element (which can embody fixture 620) can result in a plurality of oscillating signals having respective frequencies g_{K}=f_{K}(T(R_{K})), with T(R_{K}) indicated temperature at position R_{K}.

The plurality of oscillating signals can produce a specific interference pattern that can be characteristic of a temperature profile of the fixture 620 having the plurality of crystal oscillator units {C_{K}}. Such pattern can be a fingerprint of the temperature profile. In one embodiment, processor unit 612 can collect the plurality of oscillating signals generated from the plurality of crystal oscillator units, and can multiplex them into a single, processed oscillating signal. In an aspect, processor unit 612 can include an actinide oxide-based multiplexer unit (also referred to as multiplexer) to generate such single, processed oscillating signal. In response to demultiplexing, which can be performed by a suitable unit (e.g., detection unit 750), the set of frequencies g_{K} can be determined and thus, a temperature distribution throughout the nuclear fuel element can be determined. In addition or in the alternative, in implementations in which temperature dependence of f_{K} can be matched for the plurality of crystal oscillator units {C_{K}}, variation in temperature throughout the nuclear fuel element can be determined.

Processor unit 612 can manipulate (e.g., process) an oscillating signal originated from the one or more crystal oscillator unit(s) 630 and indicative of the operating condition of a radioactive environment (e.g., nuclear reactor core) in accordance with a transmission protocol (e.g., amplitude modulation, amplitude shift keying (ASK), frequency modulation, frequency shift keying (FSK), phase modulation, phase shift keying (PSK), etc.). The transmission protocol determines, at least in part, various schemes for wireless communication of signal modulation (amplitude modulation (AM), frequency modulation (FM), etc.), multiplexing, amplification (e.g., linear mode), filtering (e.g., low-pass, bandpass, high-pass) which can be dictated, at least in part, by the transmission protocol. In an aspect, processor unit 612 can modulate the oscillating signal. In certain embodiments, to at least such end, processor unit 612 can comprise an actinide oxide-based modulator unit (not shown) to modulate the oscillating signal. In another aspect, processor unit 612 can amplify the oscillating signal; in certain embodiments, to at least that end, processor unit 612 can include an actinide oxide-based amplifier (not shown). In yet another aspect, processor unit 612 can multiplex a group of signal streams, e.g., produced by a plurality of crystal oscillator units of the one or more crystal oscillator unit(s) 630; as described supra, each one of the plurality of oscillating signal has at least distinctive oscillating frequency. To at least such end, in certain embodiments, processor unit 612 can include an actinide oxide-based multiplexer unit (not shown).

In certain implementations, to provide data indicative of neutron spectroscopy, or data indicative of burnup of select isotopes, or both, in a radioactive environment, such as power output level of nuclear reaction(s) that occur in the radioactive environment and neutron energy spectrum of neutrons present in such environment, processor unit 612 can be coupled to a detection unit 614 and can process signal (e.g., electric current) generated by the detection unit 614. In one embodiment, the detection unit 614 can comprise an actinide layer that, when coupled to the processor unit 612, can permit direct measurement of the burnup of a selected isotope by monitoring the fission rate in that isotope. In one aspect, directly probing the mass of the actinide layer can permit, for example, a direct correlation to the burnup of mixed oxide fuel and various transuranics. In one embodiment, the detection unit 614 can be an actinide-oxide heterostructure having a plurality of two or more layers of fission material conformally or epitaxially grown along a specific direction (e.g., the growth direction of the heterostructure). Each layer of fission material (e.g., an isotopic enriched species of an actinide oxide-based material) has a specific fission threshold. Accordingly, in an aspect, inclusion of a fission material with a disparate energy threshold for fission provides an additional energy channel, or energy bin, for performing neutron spectroscopy. In addition, detection unit 616 can include circuitry suitable for selecting signal output, e.g., current output from a layer of fission material. Such circuitry can include a first voltage source for application of a read-out voltage. Detection unit 616 also can include circuitry suitable for outputting a selected signal (e.g., electric current); such circuitry can be a driver. Moreover, detection unit 616 can include a second voltage source for application of a gate voltage that determines, at least in part, sensitivity (e.g., current output) of detection unit 616. In certain implementations, processor unit 612 can read out each layer of fission material and generate a multiplexed oscillating signal resulting from amplification of a base oscillating signal according to a current read out from a layer of fission material.

One or more layers of fission material in detection unit 616 can comprise at least one actinide element and one or more isotopes thereof. In an aspect, the at least one actinide element can comprise uranium, and the one or more isotopes can comprise one or more of ²³³U, ²³⁴U, ²³⁵U, or ²³⁸U. Pertinent, yet not exclusive, features of such isotopes include: (i) ²³⁸U is a threshold fissioning isotope responsive to neutrons with energy above 0.5 MeV, and (ii) ²³⁵U fissions for thermal neutrons and fast neutrons. In another aspect, the at least one actinide element comprises plutonium and the one or more isotopes comprise one or more of ²³⁸Pu, or ²³⁹Pu. In yet another aspect, the at least one actinide element can comprise thorium and the one or more isotopes can comprise ²³²Th. In still another aspect, the at least one actinide element comprises americium and the one or more isotopes comprise ²⁴¹Am. In certain alternative or additional aspects, the one or more isotopes of the at least one actinide element can comprise one or more of ²³³U, ²³⁴U, ²³⁵U, or ²³⁸U, ²³⁸Pu, or ²³⁹Pu, ²³²Th, and ²⁴¹Am. The larger the number of actinide materials and related isotopes employed in detection unit, the richer the spectroscopy data relate to neutron spectrum in the radioactive environment.

In certain implementations, processor unit 612 receives a signal (e.g., electric current) from detection unit 616 and utilizes such signal to amplify a base, or non-processed, oscillating the signal received from a crystal oscillator unit of the one or more crystal oscillator unit(s) 630. For instance, an actinide-oxide based amplifier that is part of processor unit 612 can amplify the base oscillating signal in current mode, in which a current received from detection channel in detection unit 616 is employed to conduct such amplification. It should be appreciated that processor unit 612 also can operate on an oscillating signal so amplified in accordance with a transmission protocol (e.g., 802.11a,b,n or other standard radio communication protocol).

As described hereinbefore, actinide oxide-based monitoring unit 610 is monolithic and self-powering. The radioactive environment (e.g., radioactive environment 140) provides a source of heat that can drive a thermopile such as those described hereinbefore. In an embodiment, power unit 614 can be a thermopile formed from at least one junction among a first actinide oxide (e.g., UₓO_{y} such as UO₂ or U₃O₈) with a first doping type (e.g., P-type or N-type) and a second actinide oxide (e.g., UₓO_{y} such as UO₂ or U₃O₈) with a second doping type (such as N-type or P-type) distinct from the first type. For example, power unit 614 can be embodied in P-N junction (e.g., junction 310). In another embodiment, power unit 614 can be a thermopile from at least one junction among a first actinide oxide material (e.g., UₓO_{y} such as UO₂ or U₃O₈) with a first doping type (e.g., P-type or N-type) and an intrinsic actinide oxide (e.g., UₓO_{y} such as UO₂ or U₃O₈) and at least one junction among a second actinide oxide material (e.g., UₓO_{y} such as UO₂ or U₃O₈) and a second doping type (such as N-type or P-type) distinct from the first doping type.

In addition to exploiting heat present in the radioactive environment (e.g., nuclear reactor core), the radioactive nature of the actinide-based oxide material (e.g., UₓO_{y} such as UO₂ or U₃O₈) can provide a current of charged carriers (e.g., electrons or holes) in response to resulting, in part, from fission events triggered by neutrons present in radioactive environment (e.g., the core of the nuclear reactor). In an alternative embodiment, power unit 614 can be a P-i-N junction (e.g., junction 360) formed with doped and intrinsic actinide oxide-based material (e.g., UₓO_{y} such as UO₂ or U₃O₈ or AcₓO_{y}, where Ac is an alpha, beta, or spontaneous fissioning actinide isotope) in which electron-hole (e-h) pairs are formed as a result of such alpha decay ionization. In certain scenarios, production of substantive amounts of e-h pairs (e.g., amounts of the order 10⁹ e-h pairs) can be accomplished through fission events releasing about 195 MeV of energy. Such e-h pairs can produce a voltage than can energize, and drive operation of, actinide oxide-based monitoring unit.

After processing of an oscillating signal, processor unit 612 can convey a resulting oscillating signal to fixture 620 and cause an excitation of fixture 620 that delivers wirelessly the resulting signal. Fixture 620, or a portion thereof, operates as an antenna structure for wireless transmission.

FIG. 7 illustrates an exemplary embodiment 700 of an exemplary monitoring system 700 in combination with a detection unit 710. The representation of exemplary embodiment 700 is pictorial and thus not to scale. Actinide oxide-based monitoring unit 610 can receive a non-processed oscillating signal from one or more crystal oscillator unit(s) 630 as described supra. In response to receiving the non-processed oscillating signal, actinide oxide-based monitoring unit 610 can process the non-processed oscillating signal and supply it to a cladding 720 of a nuclear fuel rod 710. Cladding 720 and the fuel rod 710 embody fixture 620 present in FIG. 6. Cladding 720 is excited by the oscillating signal supplied by the actinide oxide-based monitoring unit 610 and, in response, emits electromagnetic radiation in the form of an oscillating signal 730. In an aspect, the frequency of oscillating signal 730 is of the order of a MHz. In certain embodiments, processor unit 612 can up-convert or down-convert the non-processed oscillating signal to cause the cladding 720 to emit in frequencies of the order of about a Hz to about a GHz.

Operation in such frequency regime provides oscillating signals with a wavelength of the order of a few meters (e.g., 1-10 meters), which can penetrate substantive distances and are not significantly scattered within dense media such as pressure vessels in a nuclear reactor, react fuel material (also referred to as “fuel meat”), or coolant material (water, deuterium, etc.)

Wireless detector unit 740 (also referred to as wireless detector 740) is configured (e.g., programmed with computer-executable instructions) to receive the oscillating signal 730. Wireless detector 740 can demodulate, demultiplex, or otherwise process the oscillating signal 730 in accordance with the transmission protocol in order to extract data indicative of at least one parameter related to the operating condition of the radioactive environment, e.g., the nuclear reactor core. The at least one parameter can include one or more of the temperature of a fuel element (e.g., a fuel rod) or a portion (e.g., location) thereof, a neutron yield (which can be expressed in units of (MeV sr)⁻¹ where sr is the notation for steradian, a unit of solid angle), or a power value.

In an aspect, detection unit 740 can extract the at least one parameter in accordance with various modalities based at least on the operating condition of the radioactive environment (e.g., a nuclear reactor core). As an example, when the operating condition of the radioactive environment (e.g., the nuclear reactor core) is output power, detection unit 740 can determine the amplitude of the oscillating signal 730, and determine a value of the output power of the radioactive environment (e.g., the nuclear reactor core) based on the determined amplitude.

In a scenario in which the operating condition of the radioactive environment (e.g., the nuclear reactor core) is temperature in a nuclear fuel structure (e.g., a fuel rod), detection unit 740 can determining a Doppler shift of the oscillating signal 730 with respect to a disparate oscillating signal previously and wireless received. In a scenario in which the operating condition of the radioactive environment (e.g., the nuclear reactor core) is at least a portion of neutron energy spectrum, detection unit 740 can determine from the oscillating signal 730 a plurality of values of output power of the radioactive environment (e.g., the nuclear reactor core) for a plurality of specific fission threshold energies. In an aspect, to determine the portion of the neutron energy spectrum the detection unit can unfold the plurality of values of output power of the nuclear reactor for the plurality of specific fission threshold energies, and yield the portion of the neutron energy spectrum based on result(s) of the unfolding.

In view of the various aspects described hereinbefore, exemplary methods that can be implemented in accordance with the disclosed subject matter can be better appreciated with reference to the flowcharts in FIGS. 8-10. For purposes of simplicity of explanation, the exemplary methods disclosed in FIGS. 8-10 are presented and described as a series of acts or steps. However, it is to be understood and appreciated that exemplary methods 800-1000 and the various processes or methods described in the subject disclosure are not limited by the order of acts or steps, as some acts or steps may occur in different orders and/or concurrently with other acts from that shown and described herein. Moreover, not all illustrated acts or steps may be required to implement a process or method in accordance with the subject disclosure. Furthermore, two or more of the disclosed methods or processes can be implemented in combination with each other, to accomplish one or more features or advantages described herein.

FIGS. 8-10 are flowcharts of exemplary methods 800, 900, and 1000, respectively, for wirelessly monitoring operation of a radioactive environment in accordance with aspects of the subject disclosure. Exemplary method 800 is directed to producing and emitting a wireless signal indicative of feature(s) of such operation, whereas exemplary method 900 is directed to detecting the wireless signal. Regarding exemplary method 800, at step 810 an actinide oxide-based unit is provided. The actinide oxide-based unit comprises a processing circuit and a power source. In an aspect, the power source energizes at least the processing circuit. In certain embodiments, as described hereinbefore, the actinide-based unit is monolithic. In addition, the processing circuit embodies processor unit 612, and the power source embodies power unit 614.

In an aspect, providing the actinide oxide-based unit comprises providing the actinide oxide-based unit including a crystalline actinide oxide material, which can be a monocrystalline actinide oxide solid, a polycrystalline actinide oxide solid, or a combination thereof. The crystalline actinide oxide material can include an intrinsic actinide oxide material, a P-type actinide oxide material, an N-type actinide oxide material, or a combination thereof (see, e.g., FIGS. 3A-3B and FIGS. 4A-4B). In certain embodiments, providing the actinide based-oxide based unit comprises manufacturing the actinide oxide-based unit by metal organic chemical vapor deposition (MOCVD). The manufacturing by MOCVD enables providing the crystalline actinide oxide material that can be part of the actinide oxide-based unit. Accordingly, in an aspect, the manufacturing by MOCVD can include producing, and thus providing, the P-type actinide oxide material by doping the intrinsic actinide oxide material with at least one of a transition metal, a metal, or a metalloid. For instance, Si, Al, In, Pt, Ir, Os, As, Ga, or Zn can be employed as a dopant for P-type doping. Co-doping with two or more transition metals, metals, or metalloids also can be exploited to produce the P-type actinide oxide material. In another aspect, manufacturing by MOCVD can include manufacturing, and thus providing, the N-type actinide oxide material by doping the intrinsic actinide oxide material with at least one of carbon (C), nitrogen, phosphorus, arsenic, antimony, bismuth or boron (B). Co-doping with C and B or other combination of elements also is possible.

In additional or alternative embodiments, as described hereinbefore, providing the actinide based-oxide based unit can include providing the P-type actinide oxide material by regulating oxygen stoichiometry in the intrinsic actinide oxide material via MOCVD. Similarly, yet not identically, in other alternative or further embodiments, providing the actinide based-oxide based unit can include providing the N-type actinide oxide material by regulating oxygen stoichiometry in the intrinsic actinide oxide material via MOCVD. Other manufacturing process(es) that can regulate oxygen conditions (e.g., partial pressure of oxygen) during deposition of actinide oxide material can be employed to produce the P-type actinide oxide material or the N-type actinide oxide material.

In certain aspects, providing the actinide oxide-based unit includes provide one such unit comprising one or more of: (1) a P-N junction (see, e.g., FIG. 2A) of the P-type actinide oxide material and the N-type actinide oxide material, (2) an N-P-N junction of the P-type actinide oxide material and the N-type actinide oxide material, (3) a P-N-P junction of the P-type actinide oxide material and the N-type actinide oxide material, (4) a P-i-N junction of the P-type actinide oxide material, the intrinsic (i) actinide oxide material, and the N-type actinide oxide material, or (5) an N-i-P junction of the P-type actinide oxide material, the intrinsic actinide oxide material, and the N-type actinide oxide material.

Based on such elementary blocks, providing the actinide oxide-based unit can include manufacturing one or more of an actinide oxide-based logic gate, an actinide oxide-based filter, or an actinide oxide-based amplifier from at least one of the P-N junction, the N-P-N junction, the P-N-P junction, or the P-i-N junction, or a combination thereof. The manufacturing can include processing the elementary blocks with semiconductor processing techniques suitably modified to manipulate actinide oxide materials. In one or more embodiments, providing the actinide oxide-based unit comprises providing such one unit comprising one or more isotopes of at least one actinide element. In an aspect, the at least one actinide element can comprise uranium and the one or more isotopes can comprise one or more of ²³³U, ²³⁴U, ²³⁵U, or ²³⁸U. In another example, the at least one actinide element comprises plutonium and the one or more isotopes comprise one or more of ²³⁸Pu, or ²³⁹Pu. In yet another example, the at least one actinide element can comprise thorium and the one or more isotopes can comprise ²³²Th. In still another aspect, the at least one actinide element comprises americium and the one or more isotopes comprise ²⁴¹Am. In certain alternative or additional aspects, the one or more isotopes of the at least one actinide element can comprise one or more of ²³³U, ²³⁴U, or ²³⁸U, ²³⁸Pu, or ²³⁹Pu, ²³²Th, and ²⁴¹Am.

At act 820, an oscillating signal indicative of an operating condition of a radioactive environment is generated. The oscillating signal can be created at least in part by the processing circuit that is part of the actinide oxide-based unit. In an aspect, the operating condition can comprise the temperature of nuclear fuel contained in the radioactive environment, the power output level of nuclear reaction(s) that occur in the radioactive environment, and the neutron energy spectrum of neutrons present in the radioactive environment. In an embodiment, generating such oscillating signal can include coupling the actinide oxide-based unit to one or more crystal oscillator units that generate a non-processed oscillating signal indicative of the operating condition of the radioactive environment, and yielding the oscillating signal indicative of the performance condition of the radioactive environment by processing (manipulating, operating on, amplifying, etc.) the non-processed oscillating signal. A processing circuit that is included in the actinide based-oxide unit can perform such processing.

In an aspect, processing the non-processed oscillating signal can comprise modulating the non-processed oscillating signal indicative of the operating condition of the radioactive environment. In another aspect, processing the non-processed oscillating signal can comprise amplifying the first oscillating signal indicative of the operating condition of the radioactive environment. In yet another aspect, the generating act comprises multiplexing a plurality of oscillating signals generated by a plurality of crystal oscillator units of the one or more crystal oscillator units, wherein each one of the plurality of oscillating signal has at least distinctive oscillating frequency.

At step 830, the actinide oxide-based unit is coupled to a fixture (e.g., nuclear fuel structure) within the radioactive environment (e.g., core of a nuclear reactor). At step 840, the oscillating signal is delivered wirelessly via at least in part at least a portion of the fixture within the radioactive environment. At least the portion of the fixture can serve as an antenna.

In an exemplary embodiment of exemplary method 900, as illustrated in FIG. 9, the radioactive environment is the interior (or the core) of a nuclear reactor and the actinide oxide material is uranium oxide, such as UO₂, U₃O₈, or more generally UₓO_{y}. At step 910, a uranium oxide-based unit is provided. Providing such unit can be accomplished in accordance with the various aspects of act 810. At step 910 the uranium oxide-based unit is coupled (electrically coupled, thermally coupled, or the like) to a crystal oscillator unit, which can be part of a set of one or more crystal oscillator unit(s). As described supra, the crystal oscillator unit generates an oscillating signal at a fixed frequency that is temperature dependent. The oscillating signal can be a first oscillating signal that is processed at step 930. Processing can be accomplished as described hereinbefore. Collectively, step 920 and step 930 represent a generating act (similar, yet not identical to act 830) that yields an oscillating signal indicative of an operating condition of the nuclear reactor. At step 940, the uranium oxide-based unit is coupled to a nuclear fuel structure in the nuclear reactor. Such structure can comprise a fuel rod and a cladding, which generally is a metal structure. In an aspect, the coupling can be localized in a manner that mitigates neutron flux incident onto the uranium oxide-based and thus increases operational lifecycle of non-uranium or non-actinide functional elements in such unit. For example, in a scenario in which the fuel structure includes a fuel pin containing a fuel rod, the uranium oxide-based unit can be attached (or otherwise coupled) to a top portion of the fuel rod.

At step 940, a second oscillating signal indicative of the operating condition of the nuclear rector is delivered wirelessly. In an aspect, wirelessly delivering the second oscillating signal comprises exciting at least a portion of the nuclear fuel structure with the second oscillating signal and thus causing at least the portion of the nuclear fuel structure to transmit the second oscillating signal.

In connection with exemplary method 1000, at step 1010 an actinide oxide-based device is installed within a radioactive environment. In an aspect, as described hereinbefore (see, e.g., FIG. 7), the actinide oxide-based device can comprise an actinide oxide based monitoring unit (e.g., unit 610) functionally coupled to at least one crystal oscillator unit (e.g., crystal oscillator unit(s) 630). In another aspect, installing the actinide oxide-based device can include functionally coupling (attaching, mounting, etc.) such device to a fixture within the radioactive environment (e.g., a nuclear reactor core). In an embodiment in which the radioactive environment is the vessel of a nuclear reactor, the fixture can be at least a portion of cladding of a fuel rod, or fuel pin, in the nuclear reactor.

At step 1020, electromagnetic (EM) radiation generated by the actinide oxide-based device in response to an operating condition of the radioactive environment (e.g., nuclear reactor core) is acquired. In an aspect, as described hereinbefore, the operating condition can comprise the temperature of nuclear fuel contained in the radioactive environment, the power output level of nuclear reaction(s) that occur in the radioactive environment, and the neutron energy spectrum of neutrons present in the radioactive environment. In another aspect, the EM radiation is representative of the operating condition of the radioactive environment.

At step 1030, data indicative of at least one parameter related to the operating condition of the radioactive environment (e.g., the nuclear reactor core) is extracted. The at least one parameter can include one or more of the temperature of a fuel element (e.g., a fuel rod) or a portion (e.g., location) thereof, coolant temperature, coolant pressure, coolant quality, a neutron yield (which can be expressed in units of (MeV sr)⁻¹ where sr is the notation for steradian, a unit of solid angle), or a power value. As described hereinbefore, extracting the at least one parameter can be accomplished in various manners depending on the operating condition of the radioactive environment (e.g., a nuclear reactor core). In a scenario in which the operating condition of the radioactive environment (e.g., the nuclear reactor core) is output power, the extracting can comprise determining the amplitude of an oscillating signal received as part of the EM radiation, and determining a value of the output power of the nuclear reactor core based on such amplitude. In addition or in the alternative, in a scenario in which the operating condition of the nuclear reactor core is temperature in a nuclear fuel element (e.g., a fuel rod), the extracting can comprise determining a Doppler shift of an oscillating signal received as part of the EM radiation with respect to a previously received oscillating signal. As another alternative or in further addition, in a scenario in which the operating condition of the nuclear reactor core is at least a portion of neutron energy spectrum, the extracting can comprise determining from the EM radiation a plurality of values of output power of the radioactive environment (e.g., the nuclear reactor core) for a plurality of specific fission threshold energies; unfolding the plurality of values of output power of the nuclear reactor for the plurality of specific fission threshold energies; and yielding the portion of the neutron energy spectrum based on result(s) of the unfolding. An unfolding process can be similar to the processes recited in Sanchez, et al., “Neutron Spectra Unfolding with Artificial Neural Networks,” ENIINVIE, (2005), U.S. Pat. Appl. Pub. No. 2011/0266448. Wang, et al., “Fermilab Neutron Therapy Facility Neutron Spectrum Determination by Threshold Foils,” Proceedings of Science (PoS (FNDA2006) 041), Sunden, et al., “Evaluation of Spectral Unfolding Techniques for Neutron Spectroscopy.” EFDA-JET-CP(07)04/10, hereby incorporated herein by reference in their entirety.

From the foregoing description various advantages of the subject disclosure with respect to conventional technologies emerge. For example, the various structures employed to monitor the radioactive environment are manufactured primarily of materials (e.g., actinide oxides) that are germane to such environment. For instance, certain actinide oxide materials serve as fuel in a nuclear reactor and are burnable and have minimal effects on neutron economy in the nuclear reactor. Accordingly, units, devices, and the like, produced from such structures are resilient to the extreme operating conditions (high radiation, elevated temperatures and pressures, etc.) of the radioactive environment. For another example, monitoring is localized within the confines of the radioactive environment and can enable space-dependent monitoring of such environment. The various structures that enable monitoring the radioactive environment can be deployed and operate acceptably (e.g., within performance that satisfies at least one performance criterion) within the radioactive environment. For yet another example, information pertaining to an operating condition of the radioactive environment is transported or delivered wirelessly and thus risks associated with exposure to the radioactive environment are mitigated or avoided. In addition, operational cost associated with deployment of wires and other means for transporting data to the exterior part of the radioactive environment are avoided. For still yet another example, the structures for monitoring the radioactive environment are modular and the degree of complexity of operational monitoring units can be regulated based on various factors such as budgets, availability of manufacturing facilities, accessibility to the radioactive environment, and the like.

Semiconductor structures whose base diode structures are p-i-n, p-n, n-p built on uranium oxide, actinide oxide and transuranic based materials can be used as a remote power source. The power is created through fission product decay, alpha decay of a transuranic or other alpha emitting isotope, beta emitting isotopes, or gamma emitting isotopes similar to claims specified in the application. These units can be placed in series, parallel, or combination of parallel and series. The uranium oxide or transuranic oxide power source can be tuned for duration of operation and required power output through selection of isotope driving the power junction, number of junctions in parallel and series. These power junctions can produce several kilowatts of power in several cubic centimeters of volume. These power junctions can be used for extended use in mobile devices requiring a constant power source including computing devices, mobile devices, communication devices, optic devices, light sources, visualization devices and the like.

In another aspect of the proposed technology, radiation hard electronics have been created. These radiation hard electronics are the core of the in-core sensors. The only reason they can tolerate an entire fuel cycle duration in the reactor core is through the radiation hardness. The binary nature of the semiconductor, Uranium and oxygen, the semiconductor material is less susceptible to radiation induced damage. Through the creation of diode structures which can form the basic building blocks of transistors, amplifiers, logic circuits as well as higher order electronic circuits up through those of computer chips and processors, the uranium oxide semiconductor can provide the basis for the most radiation resilient semiconductor structures who are also capable of sustained operation in excess of 1000 C. The diode structures obtain these characteristics only through their pristine growth and fabrication. These outperform all other semiconductor structures. They provide electronics which are insensitive to EM radiation, gamma and x-ray radiation, as well as alpha, beta and fission product radiation. These can be used in satellite electronics as well as other military type electronics requiring a radiation resistant capability.

While the systems, devices, apparatuses, protocols, processes, and methods have been described in connection with exemplary embodiments and specific illustrations, it is not intended that the scope be limited to the particular embodiments set forth, as the embodiments herein are intended in all respects to be illustrative rather than restrictive.

Unless otherwise expressly stated, it is in no way intended that any protocol, procedure, process, or method set forth herein be construed as requiring that its acts or steps be performed in a specific order. Accordingly, in the subject specification, where description of a process or method does not actually recite an order to be followed by its acts or steps or it is not otherwise specifically recited in the claims or descriptions of the subject disclosure that the steps are to be limited to a specific order, it is no way intended that an order be inferred, in any respect. This holds for any possible non-express basis for interpretation, including: matters of logic with respect to arrangement of steps or operational flow, plain meaning derived from grammatical organization or punctuation, the number or type of embodiments described in the specification or annexed drawings, or the like.

It will be apparent to those skilled in the art that various modifications and variations can be made in the subject disclosure without departing from the scope or spirit of the subject disclosure. Other embodiments of the subject disclosure will be apparent to those skilled in the art from consideration of the specification and practice of the subject disclosure as disclosed herein. It is intended that the specification and examples be considered as non-limiting illustrations only, with a true scope and spirit of the subject disclosure being indicated by the following claims.

What is claimed is:

1. A device, comprising:
one or more crystal oscillator units configured to generate a first oscillating signal;
an actinide oxide-based unit functionally coupled to at least one of the one or more crystal oscillator units, the actinide oxide-based unit configured to receive the first oscillating signal, and to generate a second oscillating signal based on the first oscillating signal; and
an antenna that receives the second oscillating signal and delivers the second oscillating signal wirelessly.

2. The device of claim 1, further comprising one or more crystalline devices generating power through fission, radioactive decay, or thermal energy converted to electrical energy, or a combination thereof, wherein the one or more crystalline devices drives the one or more crystal oscillator units.

3. The device of claim 1, wherein the actinide oxide-based unit comprises a power unit that energizes at least a portion of the actinide oxide-based unit.

4. The device of claim 1, wherein the first oscillating signal and the second oscillating signal are indicative of a condition of a nuclear reactor comprising the actinide oxide-based unit.

5. The device of claim 4, wherein the actinide oxide-based unit is contained within a vessel of the nuclear reactor.

6. The device of claim 4, wherein the antenna is a cladding of a fuel structure in a nuclear reactor.

7. The device of claim 6, wherein the one or more crystal oscillator units are distributed at various positions on the fuel element of the fuel structure.

8. The device of claim 1, wherein the actinide oxide-based unit comprises a crystalline actinide oxide material.

9. The device of claim 8, wherein the crystalline actinide oxide material is a monocrystalline actinide oxide solid, a polycrystalline actinide oxide solid, or a combination thereof.

10. The device of claim 9, wherein the crystalline actinide oxide material comprises an intrinsic actinide oxide material, a P-type actinide oxide material, and an N-type actinide oxide material.

11. The device of claim 10, wherein the actinide oxide-based unit comprises at least one of:
a P-N junction of the P-type actinide oxide material and the N-type actinide oxide material;
an N-P-N junction of the P-type actinide oxide material and the N-type actinide oxide material;
a P-N-P junction of the P-type actinide oxide material and the N-type actinide oxide material;
a P-i-N junction of the P-type actinide oxide material, the intrinsic (i) actinide oxide material, and the N-type actinide oxide material; or
an N-i-P junction of the P-type actinide oxide material, the intrinsic actinide oxide material, and the N-type actinide oxide material.

12. The device of claim 11, wherein the actinide oxide-based unit comprises at least one logic gate manufactured from at least one of the P-N junction, the N-P-N junction, the P-N-P junction, or the P-i-N junction.

13. The device of claim 12, wherein the actinide oxide-based unit comprises an amplifier and a filter.

14. The device of claim 3, wherein to generate the second oscillating signal, the processing unit is further configured to modulate the first oscillating signal.

15. The device of claim 14, wherein the power source supplies a current to the processing unit and, in response, the processing unit amplifies a modulated realization of the first oscillating signal.

16. The device of claim 1, wherein the one or more crystal oscillator units comprise at least one of a zinc oxide crystal, a silicon oxide crystal, or a zirconium oxide crystal.

17. The device of claim 16, wherein a crystal of the one of the one or more crystal oscillator units is oriented along a specific crystallographic direction [symbol] qrs [symbol] , wherein q, r, and s are Miller indices.

18. The device of claim 1, wherein the actinide oxide-based unit comprises one or more isotopes of an actinide element.

19. The device of claim 18, wherein the actinide element is uranium and the one or more isotopes comprise one or more of ²³³U, ²³⁴U, ²³⁵U, or ²³⁸U.

20. The device of claim 18, wherein the actinide element is plutonium and the one or more isotopes comprise one or more of ²³⁸Pu, or ²³⁹Pu.

21. The device of claim 18, wherein the actinide element is thorium and the one or more isotopes comprise ²³²Th.

22. The device of claim 18, wherein the actinide element is americium and the one or more isotopes comprise ²⁴¹Am.

23. A method, comprising:
providing an actinide oxide-based unit comprising a processing circuit and a power source that energizes at least the processing unit;
generating by the processing circuit an oscillating signal indicative of a condition of a nuclear reactor core;
coupling the actinide oxide-based unit to a nuclear fuel structure of the nuclear reactor core; and
delivering wirelessly the oscillating signal through at least a portion of the nuclear fuel structure of the nuclear reactor core, wherein the portion of the fuel structure serves as an antenna.

24. The method of claim 23, wherein the generating act comprises:
coupling the actinide oxide-based unit to one or more crystal oscillator units that generate a first oscillating signal indicative of the operating condition of the nuclear reactor core; and
yielding the oscillating signal by processing the first oscillating signal.

25. The method of claim 23, wherein the portion of the fuel structure is a cladding of a nuclear fuel rod.

26. The method of claim 25, wherein the providing act comprises manufacturing the actinide oxide-based unit by metal organic chemical vapor deposition (MOCVD).

27. The method of claim 23, wherein the providing act comprises providing the actinide oxide-based unit comprising a crystalline actinide oxide material.

28. The method of claim 27, wherein the crystalline actinide oxide material is a monocrystalline actinide oxide solid, a polycrystalline actinide oxide solid, or a combination thereof.

29. The method of claim 28, wherein the crystalline actinide oxide material comprises an intrinsic actinide oxide material, a P-type actinide oxide material, and an N-type actinide oxide material.

30. The method of claim 29, wherein the providing act further comprises providing the P-type actinide oxide material by doping the intrinsic actinide oxide material with at least one transition metal via MOCVD.

31. The method of claim 29, wherein the providing act further comprises providing the P-type actinide oxide material by regulating oxygen stoichiometry in the intrinsic actinide oxide material via MOCVD.

32. The method of claim 29, wherein the providing act further comprises providing the N-type actinide oxide material by doping the intrinsic actinide oxide material with at least one of carbon or boron via MOCVD.

33. The method of claim 29, wherein the providing act further comprises providing the N-type actinide oxide material by regulating oxygen stoichiometry in the intrinsic actinide oxide material via MOCVD.

34. The method of claim 29, wherein the providing act comprises providing the actinide oxide-based unit comprising at least one of:
a P-N junction of the P-type actinide oxide material and the N-type actinide oxide material;
an N-P-N junction of the P-type actinide oxide material and the N-type actinide oxide material;
a P-N-P junction of the P-type actinide oxide material and the N-type actinide oxide material;
a P-i-N junction of the P-type actinide oxide material, the intrinsic (i) actinide oxide material, and the N-type actinide oxide material; or
an N-i-P junction of the P-type actinide oxide material, the intrinsic actinide oxide material, and the N-type actinide oxide material.

35. The method of claim 34, wherein the providing act further comprises manufacturing an actinide oxide-based logic gate from at least one of the P-N junction, the N-P-N junction, the P-N-P junction, or the P-i-N junction.

36. The method of claim 34, wherein the providing act further comprises manufacturing an actinide oxide-based filter from at least one of the P-N junction, the N-P-N junction, the P-N-P junction, or the P-i-N junction.

37. The method of claim 34, wherein the providing act further comprises manufacturing an actinide oxide-based amplifier from at least one of the P-N junction, the N-P-N junction, the P-N-P junction, or the P-i-N junction.

38. The method of claim 23, wherein the providing act comprises providing the actinide oxide-based unit comprising one or more isotopes of at least one actinide element.

39. The method of claim 38, wherein the at least one actinide element comprises uranium and the one or more isotopes comprise one or more of ²³³U, ²³⁴U, ²³⁵U, or ²³⁸U.

40. The method of claim 38, wherein the at least one actinide element comprises plutonium and the one or more isotopes comprise one or more of ²³⁸Pu, or ²³⁹Pu.

41. The method of claim 38, wherein the at least one actinide element comprises thorium and the one or more isotopes comprise ²³²Th.

42. The method of claim 38, wherein the at least one actinide element comprises americium and the one or more isotopes comprise ²⁴¹Am.

43. The method of claim 38, wherein the one or more isotopes of the at least one actinide element comprise one or more of ²³³U, ²³⁴U, ²³⁵U, or ²³⁸U, ²³⁸Pu, or ²³⁹Pu, ²³²Th, and ²⁴¹Am.

43. The method of claim 24, wherein the processing act comprises modulating the first oscillating signal indicative of the operating condition of the nuclear reactor core.

44. The method of claim 24, wherein the processing act comprises amplifying the first oscillating signal indicative of the operating condition of the nuclear reactor core.

45. The method of claim 24, wherein the generating act comprises multiplexing a plurality of oscillating signals generated by a plurality of crystal oscillator units of the one or more crystal oscillator units, wherein each of the plurality of oscillating signal has at least distinctive oscillating frequency.

46. A method, comprising:
acquiring electromagnetic radiation (EM) generated by an actinide oxide-based detector in response to an operating condition of a nuclear reactor core comprising the actinide oxide-based detector; and
extracting data indicative of the operating condition of the nuclear reactor core from at least the EM radiation.

47. The method of claim 46, further comprising providing the actinide oxide-based detector comprising a processing circuit and a power source that energizes at least the processing circuit.

48. The method of claim 46, wherein the operating condition of the nuclear reactor core is output power, and wherein the extracting step comprises:
determining an amplitude of an oscillating signal received as part of the EM radiation; and
determining a value of the output power of the nuclear reactor core.

49. The method of claim 46, wherein the operating condition of the nuclear reactor core is temperature in a nuclear fuel element, and wherein the extracting step comprises:
determining a Doppler shift of an oscillating signal received as part of the EM radiation with respect to a previously received oscillating signal.

50. The method of claim 46, wherein the operating condition of the nuclear reactor core is at least a portion of neutron energy spectrum, and wherein the extracting comprises:
based on the EM radiation, determining a plurality of values of output power of the nuclear reactor core for a plurality of specific fission threshold energies; and
unfolding the plurality of values of output power of the nuclear reactor for the plurality of specific fission threshold energies; and
yielding the portion of the neutron energy spectrum based on the unfolding.
